(19) United States
(12) Patent Application Publication
(10) Pub. No.: US 2022/0398539 A1
(43) Pub. Date: Dec. 15, 2022

(54) DOUBLE APPROVAL WORKFLOW MANAGEMENT SYSTEM AND METHOD

(71) Applicant: Mothership Transports Corporation, Lighthouse Point, FL (US)

(72) Inventor: llyse Shuster, Lighthouse Point, FL (US)

(21) Appl. No.: 17/346,187

(22) Filed: Jun. 11, 2021

(51) Int. Cl. G06Q 10/10; G06Q 10/06; G06Q 20/08

(52) U.S. Cl. CPC G06Q 10/103; G06Q 10/101; G06Q 10/0633; G06Q 20/0855

(57) ABSTRACT

A computer-implemented workflow and project management system and method including a double approval mechanism that allows users and freelancers to manage projects, milestones, notes, and overall deliverables effectively and efficiently. The invention addresses the common problem where while one or both parties initially agree to a certain project scope the scope and expectations of the parties can change over time and the project often gets off track from the original agreement/scope. The invention's double approval process ensures that clients and freelancers are always approving and agreeing to every project milestone and every project note before tasks are started, thereby ensuring that neither party can assert that it they did not understand the project scope.

### CROSS-REFERENCE TO RELATED APPLICATIONS

N/A

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, explain the principles of the disclosure.

In the drawings:

FIG. 1 is a system environment, according to an embodiment.

FIG. 2 describes a method for using the system, according to an embodiment.

FIG. 3 is a computing environment, according to an embodiment.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

### Overview of Workflow Management System and Method

The present invention comprises various embodiments of a computer-implemented workflow and project management system and method including a double approval mechanism that allows users and freelancers to manage projects, milestones, notes, and overall deliverables effectively and efficiently. The invention addresses the common problem where while one or both parties initially agree to a certain project scope the scope and expectations of the parties can change over time and the project often gets off track from the original agreement/scope. The invention's double approval process ensures that clients and freelancers are always approving and agreeing to every project milestone and every project note before tasks are started, thereby ensuring that neither party can assert that it they did not understand the project scope. The invention differs from traditional task or check lists because instead of the client or freelancer just reviewing the notes/tasks, they must take an affirmative step to “approve” the notes/tasks, such as by clicking an “approve” button. This affirmative step functions as a formal/written agreement and is recorded by the system with date and time stamps. The invention allows for on platform communication tools with call recording, and along with screen and time tracking to justify freelancer time spent and task execution

### Network-Enabled Platform Host and User Account Creation

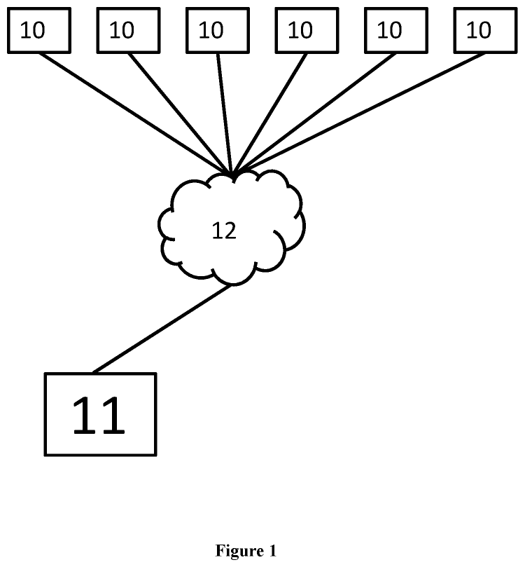

FIG. 1 illustrates one embodiment of an information system that facilitates management and execution of the system methods described herein. The system includes a one or more user devices 10 that users use to communicate with the at least one system platform host 11. The user devices 10 and the host 11 are in communication over a communications network 12 such that the user device 10 can access the host 11 to send and receive data thereto and therefrom. In some embodiments, communications network 12 comprises the Internet, cellular network, satellite network, RF communication, blue-tooth type communication, near field, or any other form of communication network capable of facilitating communication between user devices 10 and host 12. The information system, in some embodiments, comprises an internet-enabled computing system whereby the user devices 10 access an online and internet-based platform served by the platform host 11 which hosts the interactive graphical user interface and facilitates and carries out the methods described herein.

A communications link is established between a plurality of user devices 10 and the platform host 11. The platform host 11 receives a request from one or more user devices 10 to establish an account. The request includes one or more user-specific data points such registration information to the platform host 11 including name, username, e-mail address, date of birth, billing address, password, and payment information. The platform host 12 establishes an account based on the user data points. The platform host 12 registers an account associated with the user device 10 and validates the user associated with the user device 10 going forward. The platform host 10 assigns to each registered user an encrypted storage unit (for example, cloud storage) that contains all of the user's data, information, documents, and the like associated therewith. In some embodiments, the platform host 11 makes available a graphical user interface based on the account data points, which user interface includes plurality of workflow and project management functions. In some embodiments, upon account registration the system automatically enables a cloud-based document management and creation platform, such that the user can create, modify, and share documents and work product directly from within the system environment.

### Client-Provider Work-Flow Management

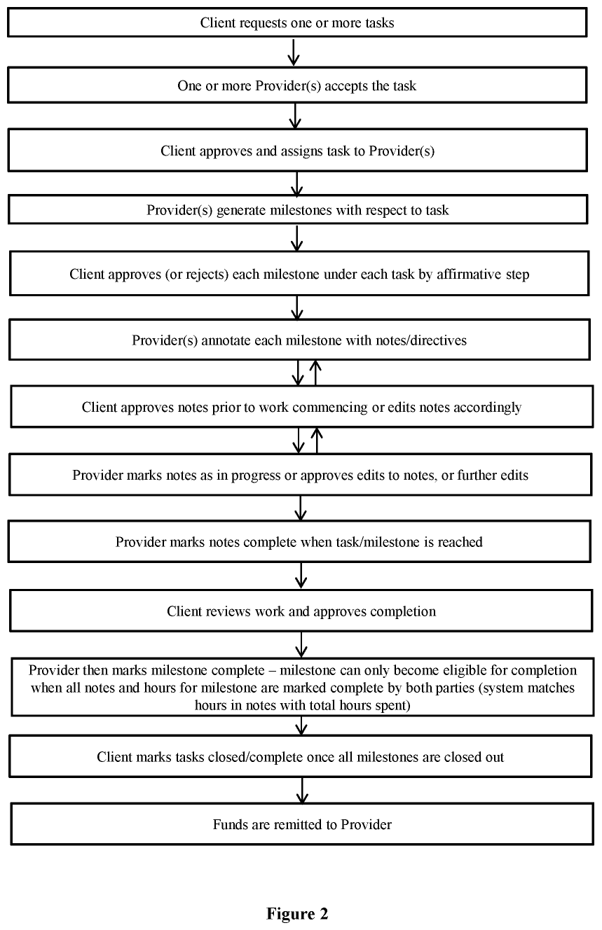

With reference to FIG. 2, shown is an example of the method steps associated with one embodiment of the invention. Here, system users are delineated as either a Client or a Provider, with the Client being the requesting and paying party, and the Provider being the party assigned to carry out a task or project through to completion. Initially, a Client requests one or more tasks by inputting appropriate data into the system. Next, one or more Providers accepts each task, and a notification of same can be sent to the Client. The Client can then choose to accept or reject the offer from the Provider(s) or chose to wait for additional Providers (or send another task request). If the Client approves the Provider, then the one or more tasks is assigned to the Provider.

The Provider then generates milestones with respect to each task, the milestones being defined as sub-parts of the tasks. Next, the Client is sent a request to approve or reject each milestone by taking an affirmative step, i.e. a positive interaction with the system to generate a notification back to the Provider as to whether the task has been accepted (or rejected). As an optional step, the Provider then annotates each milestone with notes, such as directives and goals for how each milestone will be achieved. The Client then reviews and either approves, rejects, or modifies the notes prior to work commencing. The Provider and Client engage in a back and forth regarding the milestone notes until the Client is satisfied with the directives to be undertaken and goals to be achieved for each milestone. Once the Client has approved the notes, milestones, and tasks, the Provider commences work.

As the project progresses, the Provider makes notes complete which then must be reviewed and approved by the Client. Only once the Client approves each note for a given milestone and the Provider confirms such completion can the milestone be deemed completed. The system is also configured to match the number of hours spent on a milestone to the number of hours budgeted for the overall project to assure that the Provider is staying on track with the scope of the project. The above process is repeated until all milestones for a give task are completed and approved by the Client. At that point, with all notes for each milestone completed and approved, and with each milestone completed and approved, the task is deemed completed and approved and funds are remitted to the Provider by the Client.

The method is further explained from a Client-side perspective, as follows: the Client requests one or more tasks by inputting appropriate data into the system. Next, one or more Providers accepts each task, and the Client receives a notification of same. The Client can then choose to accept or reject the offer from the Provider(s) or chose to wait for additional Providers (or send another task request). If the Client approves the Provider, then the system transmits one or more approved tasks to be assigned to the Provider.

Next, the Client is sent a request to approve or reject each milestone, based on milestone data generated by the Provider. The Client takes an affirmative step, i.e. a positive interaction with the system, which generates a notification back to the Provider as to whether the task has been accepted (or rejected). The Client then receives and reviews and either approves, rejects, or modifies notes generated by the Provider prior to work commencing. Approval, rejection, or modification data is then sent to the Provider. Once the Client has approved the notes, milestones, and tasks, the Provider commences work based on a “start” notification initiated by the Client.

As the project progresses, the Provider makes notes complete which then are received by the Client for review and approval. Only once the Client approves each note for a given milestone and the Provider confirms such completion can the milestone be deemed completed. The above process is repeated until all milestones for a give task are completed and approved by the Client. At that point, with all notes for each milestone completed and approved, and with each milestone completed and approved, the task is deemed completed and approved and funds are remitted to the Provider by the Client.

### Payment Functionality

In order to enhance project and workflow management, the system and method can optionally include various payment methodologies including the use of application programming interfaces (APIs) to third party payment processes to track and manage payments from the Client to the Provider. In some embodiments, a tokenized payment management system is implemented whereby the cost of a project is scoped and then the client purchases through the system tokens which have a corresponding monetary value. The Client can then use the tokens as virtualized currency through which to pay Providers for tasks. In some embodiments, unused tokens can be retained by the Client and applied to other tasks or milestones or can be used to pay different Providers that the Provide to whom the tokens were initially designated. This allows the Client to control budgeting by pre-purchasing a predetermined number of tokens (with a corresponding currency value) and then initial payment of tokens to Providers upon completion of tasks. In this way, the system can offer a payment management system to control or eliminate disputed regarding payment or pricing by and among the Clients and Providers. In some embodiments, the third-party payment processor and/or the tokenized payment system can be blockchain-enabled and/or can be configured to be compatible with cryptocurrency of various configurations.

### User Experience

The system and method of the present invention can be enhanced through various communication protocols and functionality including text messaging, instant messaging, video conference, voice messaging and voice-over-IP audio communication options. The system also includes document management which allows for collaborative editing and review of documents and other deliverables. For example, the document management functionality can also be used to share approvals for tasks, milestones, and notes as outlined above.

### Explanation of Computing Environment

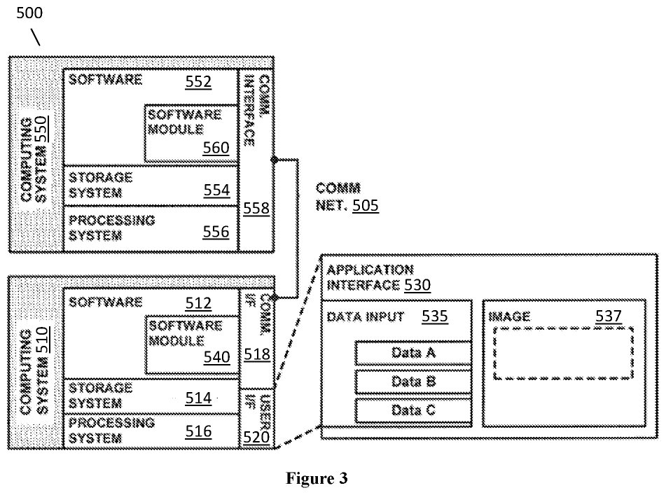

FIG. 3 illustrates a computing environment 500 according to one embodiment. Computing environment 500 includes computing system 510 and computing system 550. Computing system 510, in the present example, corresponds to user devices 110 that can send and receive data and information, and computing system 550 corresponds to system platform host 150 that can also send and receive data and information. Computing system 510 can include any smart phone, tablet computer, laptop computer, or other computing or mobile device capable of reading, and/or recording data about systems, devices, locations, and/or equipment, etc. Computing system 550 can include any server computer, desktop computer, laptop computer, or other device capable of storing and managing data communication by and between one or more computing systems 510 and other similar computing systems. Either system 510 or 550 can be capable of accomplishing any of the steps of functions described in this description.

In FIG. 3, computing system 510 includes processing system 516, storage system 514, software 512, communication interface 518, and user interface 520. Processing system 516 loads and executes software 512 from storage system 514, including software module 540. When executed by computing system 510, software module 540 directs processing system 516 to receive data, images, devices, locations, and/or equipment, etc. Such data could include any of the information described above, including but not limited to the functionality described herein.

Although computing system 510 includes one software module in the present example, one or more modules could provide the same operation. Similarly, the computing systems may be distributed using other computing systems and software.

Additionally, computing system 510 includes communication interface 518 that can be further configured to transmit data to and receive data from computing system 550 using communication network 505 (which represents the communications network 105 show in FIG. 1). Communication network 505 could include the Internet, cellular network, satellite network, RF communication, blue-tooth type communication, near field, or any other form of communication network capable of facilitating communication between computing systems 510 and 550.

Referring still to FIG. 3, processing system 516 can comprise a microprocessor and other circuitry that retrieves and executes software 512 from storage system 514. Processing system 516 can be implemented within a single processing device but can also be distributed across multiple processing devices or sub-systems that cooperate in executing program instructions. Examples of processing system 516 include general purpose central processing units, application specific processors, and logic devices, as well as any other type of processing device, combinations of processing devices, or variations thereof. Storage system 514 can comprise any storage media readable by processing system 516, and capable of storing software 512. Storage system 514 can include volatile and nonvolatile, removable and non-removable media implemented in any method or technology for storage of information, such as computer readable instructions, data structures, program modules, or other data. Storage system 514 can be implemented as a single storage device but may also be implemented across multiple storage devices or sub-systems. Storage system 514 can comprise additional elements, such as a controller, capable of communicating with processing system 516.

Application interface 530 can include data input 535 and image display 537. In one example, data input 535 can be used to collect information and data inputs from the user. It should be understood that although computing system 510 is shown as one system, the system can comprise one or more systems to collect data.

Computing system 550 includes processing system 556, storage system 554, software 552, and communication interface 558. Processing system 556 loads and executes software 552 from storage system 554, including software module 560. When executed by computing system 550, software module 560 directs processing system 510 to store and manage the data from computing system 510 and other similar computing systems. Although computing system 510 includes one software module in the present example, it should be understood that one or more modules could provide the same operation.

Additionally, computing system 550 includes communication interface 558 that can be configured to send and receive data to and from computing system 510 using communication network 505.

Referring still to FIG. 3, processing system 556 can comprise a microprocessor and other circuitry that retrieves and executes software 552 from storage system 554. Processing system 556 can be implemented within a single processing device but can also be distributed across multiple processing devices or sub-systems that cooperate in executing program instructions. Examples of processing system 556 include general purpose central processing units, application specific processors, and logic devices, as well as any other type of processing device, combinations of processing devices, or variations thereof.

Storage system 554 can comprise any storage media readable by processing system 556, and capable of storing software 552 and data from computing system 510. Data from computing system 510 may be stored in a word, excel, or any other form of digital file. Storage system 554 can include volatile and nonvolatile, removable and non-removable media implemented in any method or technology for storage of information, such as computer readable instructions, data structures, program modules, or other data. Storage system 554 can be implemented as a single storage device but may also be implemented across multiple storage devices or sub-systems. Storage system 554 can comprise additional elements, such as a controller, capable of communicating with processing system 556.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. In no case is the storage media a propagated signal.

In some examples, computing systems 510 and 550 an include a user interface. The user interface can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in the user interface. The user input and output devices are well known in the art and need not be discussed at length here.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. A method of workflow management, comprising:
on a platform host, establishing a communications link with a plurality of user devices, at least one client user device and at least one provider user device;
receiving on the platform host a request from each of the user devices to register an account associated therewith, the request containing a plurality of account data points associated with the requesting user devices;
receiving on the platform host a task request from the client user device, the task request including data associated with a desired task;
on the platform host, making available the task request to the at least one provider user device;
receiving on the platform host from the provider user device an acceptance of the task request and transmitting the acceptance to the client user device;
receiving on the platform host from the client user device a confirmation of assignment of the task request and transmitting the confirmation to the provider user device;
receiving on the platform host from the provider user device one or more milestones associated with the task request and transmitting the milestones to the client user device;
receiving on the platform host from the client user device either an acceptance or a rejection of the milestone and transmitting either the acceptance or the rejection to the provider user device via a first notification;
upon acceptance of one or more milestones, receiving on the platform host from the provider user device a request to review and approve completion of each of the milestones and transmitting the request to the client user device;
receiving on the platform host from the client user device either an approval or a disapproval of the completion of each milestone and transmitting either the approval or the disapproval to the provider user device via a second notification; and
upon approval of completion of all milestones, receiving on the platform host from the client user device a payment instruction and transmitting payment the provider in accordance with a predetermined payment structure.

2. The method of claim 1, further including the step of receiving on the platform host from the provider user device notes regarding directives and goals for at least one of the milestones and transmitting the notes to the client user device.

3. The method of claim 2, further including the step of receiving on the platform host from the client user device either an acceptance, rejection, or modification of the notes and transmitting such acceptance, rejection, or modification to the provider user device.

4. The method of claim 1, wherein the payment structure comprises a tokenized payment system.

5. The method of claim 1, wherein the payment structure is enabled through a third-party payment processor application programming interface.

6. A method of workflow management, comprising:
via a platform host, establishing a communications between a plurality of user devices, the user devices comprising at least one client user device and at least one provider user device;
transmitting from the client user device to the platform host a task request including data associated with a desired task;
receiving on the client user device from the provider user device an acceptance of the task request;
transmitting from the client user device to the provider user device a confirmation of assignment of the task request;
receiving on the client user device from the provider user device one or more milestones associated with the task request;
transmitting from the client user device to the provider user device either an acceptance or a rejection of the milestone;
upon acceptance of one or more milestones, receiving on the client user device from the provider user device a request to review and approve completion of each of the milestones;
transmitting from the client user device to the provider user device either an approval or a disapproval of the completion of each milestone; and
upon approval of completion of all milestones, transmitting from the client user device to the platform host a payment instruction to enable payment to the provider in accordance with a predetermined payment structure.

7. The method of claim 6, further including the step of receiving on the client user device from the provider user device notes regarding directives and goals for at least one of the milestones.

8. The method of claim 7, further including the step of transmitting from the client user device to the provider user device either an acceptance, rejection, or modification of the notes.

9. The method of claim 6, wherein the payment structure comprises a tokenized payment system.

10. The method of claim 6, wherein the payment structure is enabled through a third-party payment processor application programming interface.
